(19) United States
(12) Patent Application Publication
(10) Pub. No.: US 2012/0084389 A1
(43) Pub. Date: Apr. 5, 2012

(54) TECHNIQUE FOR PROVIDING SERVICE THROUGH DATA CENTER

(75) Inventor: Yuji IMAI, Kawasaki (JP)

(73) Assignee: FUJITSU LIMITED, Kawasaki-shi (JP)

(21) Appl. No.: 13/151,929

(22) Filed: Jun. 2, 2011

(30) Foreign Application Priority Data
Sep. 30, 2010 (JP) 2010-220353

(51) Int. Cl. G06F 15/16

(52) U.S. Cl. 709/217

(57) ABSTRACT

A management apparatus in a data center executes: receiving, from a router that starts connecting to the data center through a VPN, data concerning specification of a virtual machine for a user terminal in a network connected to the router and data representing a request for connecting to the Internet; activating a first virtual machine satisfying the specification of the virtual machine on a computer in the data center; activating a second virtual machine for connecting to the Internet on a computer in the data center; carrying out a setting of an address by which the user terminal connects to the Internet, for the second virtual machine; transmitting an address of the first virtual machine and an address of the second virtual machine to the router; and transmitting an address of the router to the first virtual machine and the second virtual machine.

### CROSS-REFERENCE TO RELATED APPLICATIONS

This application is based upon and claims the benefit of priority of the prior Japanese Patent Application No. 2010-220353, filed on Sep. 30, 2010, the entire contents of which are incorporated herein by reference.

### FIELD

This technique relates to a technique for providing a service by using a data center.

### BACKGROUND

Conventionally, there is a technique for making a purchaser of a router to be connected to an Internet Service Provider (ISP) to easily carry out a setting for the Internet connection within the router by obtaining setting information of the router from a network. In this technique, when the router is connected to a modem, the router accesses a broadband access server. Then, after the router is authenticated by a Remote Authentication Dial In User Service (RADIUS) server, the router is authenticated by a device authentication server. After that, the router obtains the setting information used when connecting to an ISP server, from an ISP download server. The router sets the obtained setting information by itself, connects with the ISP server based on the setting information, and obtains Hyper Text Markup Language (HTML) data of a web page on the Internet through the ISP server.

Moreover, conventionally, there is a technique for utilizing a system using a virtual machine on a cloud data center from a customer's intranet. In this system, the virtual machine that executes a customer's task is invoked on a physical server in the cloud data center, and the virtual machine provides a service usable for the customer's task to a terminal connected with the customer's intranet.

However, in this conventional technique, an engineer of the cloud data center carries out a logical design and/or construction task for the system including the virtual machines according to the user's demand. In addition, the customer also carries out the setting task for connecting to the virtual machine in the cloud data center. Accordingly, the workloads of the engineer and customer increase.

Moreover, in the conventional technique, when the customer not only uses the virtual machine from a terminal of the customer and but also causes the terminal to connect to the Internet, the user is required to additionally carry out the setting for the connection to the Internet, and security design and setting, for the router. In addition, when the virtual machine that is prepared in the cloud data center is connected to the Internet, the engineer is required to additionally carry out a task for the connection to the Internet in the cloud data center.

### SUMMARY

A management method relating to a first aspect of an embodiment is executed by a management apparatus in a data center. Then, this method includes: (A) receiving, from a router that starts connecting to a data center through a first network, data concerning specification of a virtual machine for a user terminal in a second network connected to the router and data representing a request for connecting to a third network; (B) activating a first virtual machine satisfying the specification of the virtual machine on a computer in the data center; (C) activating a second virtual machine for connecting to the third network on a computer in the data center; (D) carrying out a setting of an address by which the user terminal connects to the third network, for the second virtual machine; (E) transmitting an address of the first virtual machine and an address of the second virtual machine to the router; and (F) transmitting an address of the router to the first virtual machine and the second virtual machine.

A router relating to a second aspect of the embodiment is a router relaying communication between a first network and a second network. Then, this router has (A) a data storage unit storing data concerning specification of a virtual machine for a user terminal in the second network, and connection request data representing a connection request to a third network; (B) a reader that reads out the data concerning the specification of the virtual machine and the data connection request data from the data storage unit, upon connecting to a data center through the first network; (C) a communication unit that transmits the data concerning the specification of the virtual machine and the data connection request data, which are read out by the reader, to the data center through the first network, and receives, from the data center, connection information including an address of a first virtual machine satisfying the specification of the virtual machine and an address of a second virtual machine that carries out a processing for connecting to the third network; and (D) a setting unit that carries out a setting for communicating with the first virtual machine and the second virtual machine by using the connection information received by the communication unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a system outline diagram relating to a first embodiment;

FIG. 2 is a functional block diagram of a management apparatus relating to the first embodiment;

FIG. 3 is a functional block diagram of a router relating to the first embodiment;

FIG. 4 is a diagram depicting a processing flow of a system relating to the first embodiment;

FIG. 5 is a system outline diagram relating to a second embodiment;

FIG. 6 is a functional block diagram of an IT cell manager;

FIG. 7 is a functional block diagram of a router manager;

FIG. 8 is a functional block diagram of a router;

FIG. 9 is a diagram depicting an example of data stored in a database;

FIG. 10 is a diagram depicting a processing flow of the system relating to the second embodiment;

FIG. 11 is a diagram depicting a processing flow of the system relating to the second embodiment;

FIG. 12 is a diagram depicting a router of Ethernet Over IP set in the second embodiment; and

FIG. 13 is a functional block diagram of a computer.

### DESCRIPTION OF EMBODIMENTS

### Embodiment 1

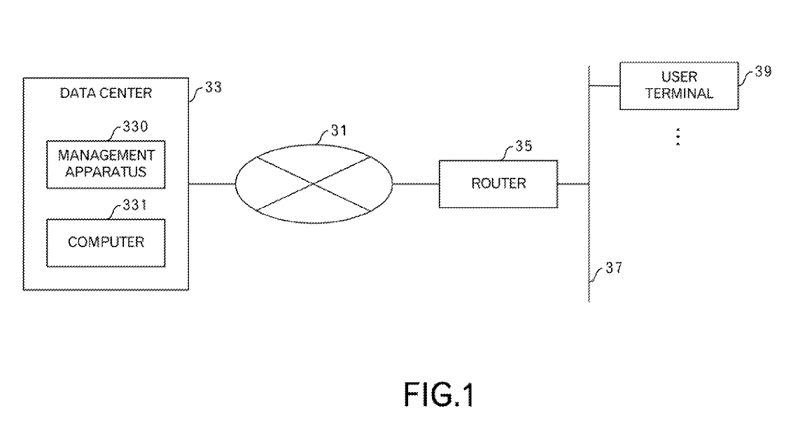

FIG. 1 illustrates a system outline relating to a first embodiment of this technique. For example, a data center 33 including a management apparatus 330 and computer 331 and router 35 are connected to a first network 31 such as a Point to Point Protocol over Ethernet (Registered Trademark) (PPPoE) network provided by a communication carrier. Moreover, one or plural user terminals 39 are connected through a second network 37 such as an intranet are connected to the router 35. Furthermore, the computer 331 includes resources such as physical server, and the management apparatus 330 uses the resources to provide the service to the user terminal 39.

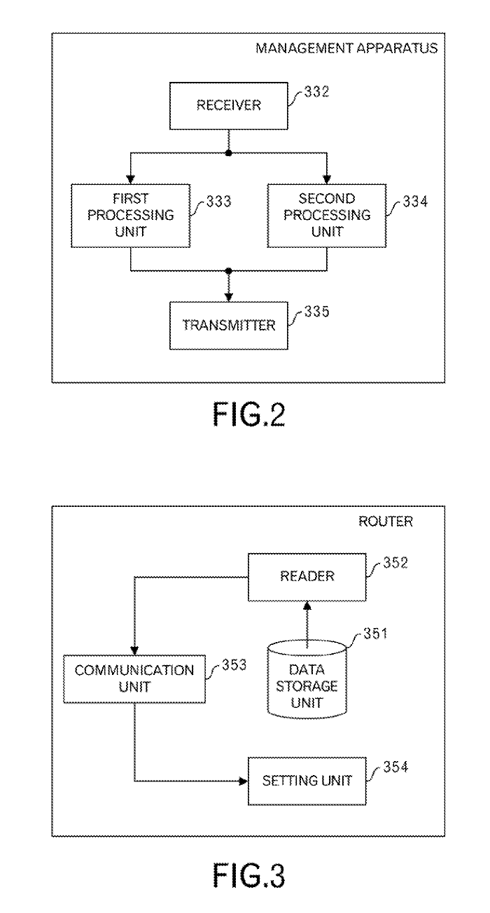

FIG. 2 illustrates a functional block diagram of the management apparatus 330. The management apparatus 330 includes a receiver 332, first processing unit 333, second processing unit 334 and transmitter 335. The receiver 332 receives data from the router 35, and outputs the received data to the first processing unit 333 and second processing unit 334. The first processing unit 333 carries out a processing using the data received from the receiver 332, and outputs processing results to the transmitter 335. The second processing unit 334 carries out a processing using the data received from the receiver 332, and outputs processing results to the transmitter 335. The transmitter 335 carries out a processing to output the processing results from the first processing unit 333 and second processing unit 334 to the router 35 and other processing.

FIG. 3 illustrates a functional block diagram of the router 35. The router 35 includes a data storage unit 351, reader 352, communication unit 353 and setting unit 354. The reader 352 reads out data from the data storage unit 351 and outputs the read data to the communication unit 353. The communication unit 353 carries out a processing to transmit the data received from the reader 352 and other processing, and receives processing results from the data center 33 to output the processing results to the setting unit 354. The setting unit 354 carries out a setting for routing by using data received from the communication unit 353 and other processing.

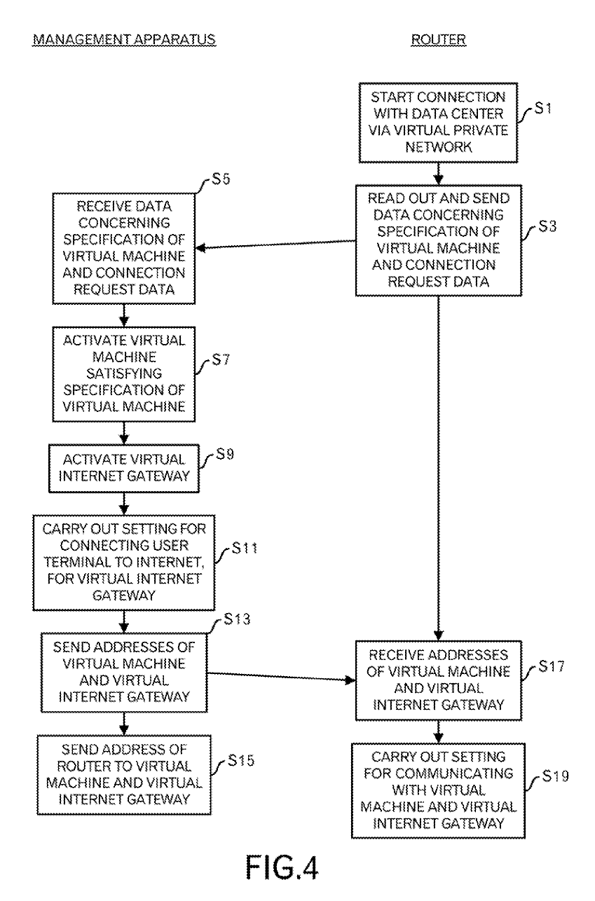

Next, processing contents of the system illustrated in FIG. 1 is explained by using FIG. 4. First, the router 35 uses connection information (e.g. PPPoE-ID and password) that is set in advance in the router 35 to connect the data center 33 through a Virtual Private Network (VPN) (e.g. IP-VPN) (FIG. 4: step S1). Incidentally, the connection information is information that was set in the manufacturing into the router 35, for example.

Then, the reader 352 reads out data concerning specification of the virtual machine and connection request data from the data storage unit 351, and the communication unit 353 transmits the read data to the data center 33 (step S3). The data concerning the specification of the virtual machine includes a type of an Operating System (OS), capacity of a hard disk drive, capacity of a memory and the like. In addition, the connection request data is data representing a request for connecting to the Internet.

When the receiver 332 in the management apparatus 330 receives the data concerning the specification of the virtual machine and connection request data from the router 35, the receiver 332 stores the received data into a storage device such as a main memory (step S5).

Then, the first processing unit 333 uses data concerning the specification of the virtual machine, which was received at the step S5, to activate a virtual machine that satisfies the specification of the virtual machine on the computer 331 (step S7). At the step S7, the virtual machine is activated by using a file of a Virtual Machine (VM) image, for example.

Moreover, the second processing unit 334 activates a virtual internet gateway for connecting to the Internet on the computer 331 (step S9). At the step S9, the virtual machine for the virtual internet gateway is activated by using a file of the VM image, for example. Furthermore, the second processing unit 334 carries out the setting of an address (e.g. IP address) used by the user terminal 39 for the connection to the Internet, for the virtual internet gateway (step S11). For example, a setting for conversion between the address of the router 35 and a global address (e.g. Network Address Translation (NAT)) is carried out for a table in the virtual internet gateway.

Then, the transmitter 335 transmits the address of the activated virtual machine and address of the activated virtual internet gateway to the router 35 (step S13). Moreover, the transmitter 335 transmits an address of the router 35 to the activated virtual machine and virtual internet gateway (step S15). After the processing at the step S15, the virtual machine and virtual internet gateway carry out a setting for connection with the router 35 (e.g. setting for communication by Ethernet Over IP (RFC3378)) for a table in the virtual machine and virtual internet gateway.

On the other hand, the communication unit 353 in the router 35 receives the address of the activated virtual machine and virtual internet gateway from the management apparatus 330 (step S17). Then, the setting unit 354 carries out the setting for the communication with the virtual machine and virtual internet gateway (step S19).

By carrying out the aforementioned processing, the user terminal can utilize the virtual machine and the Internet. Incidentally, the internet gateway is provided in the data center 33 and security setting task and the like are not carried out at the user side. Therefore, it is convenient for the user.

### Embodiment 2

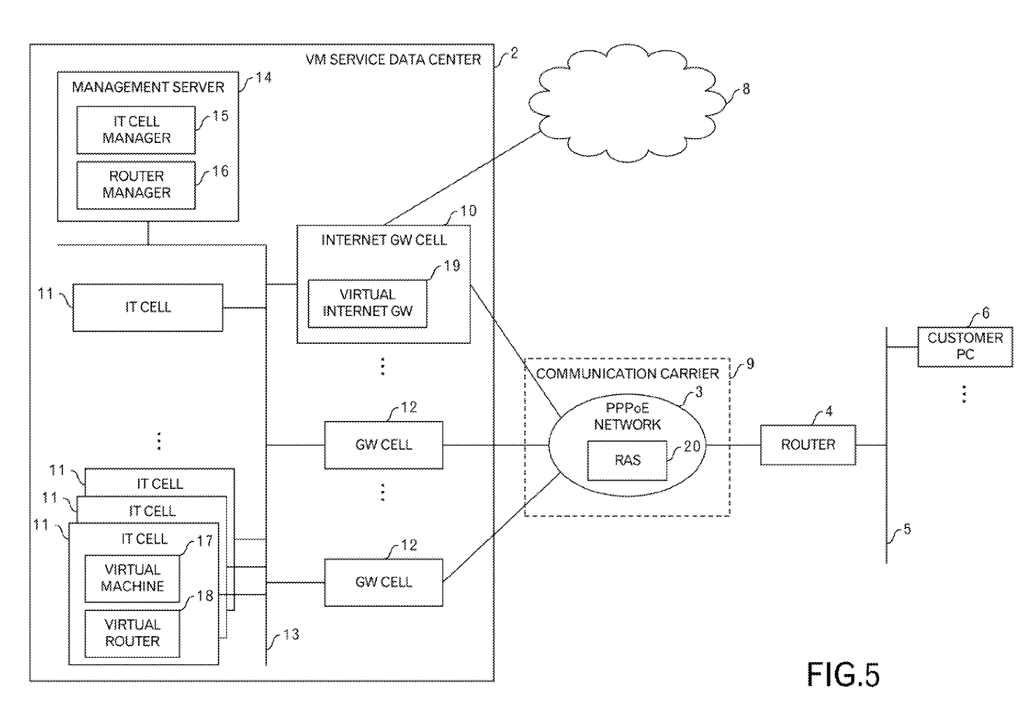

FIG. 5 illustrates a system outline relating to a second embodiment of this technique. A VM service data center 2 and router 4 are connected to a PPPoE network 3 that is a Wide Area Network (WAN) provided by a communication carrier 9. The router 4 is connected with a network 5 such as intranet, and one or plural user Personal Computers (PC) 6 are connected to the network 5. Incidentally, PPPoE is a protocol for using a function of Point to Point Protocol (PPP) through the Ethernet (Registered Trademark).

The communication carrier 9 realizes the IP-VAN by Fiber to The Home (FTTH) on the PPPoE network 3. A Remote Access Server (RAS) 20 in the communication carrier 9 carries out a processing for establishing a PPPoE session and other processing.

The VM service data center 2 is a data center that provides the customer PC 6 with a platform to execute software packages and/or application programs through the PPPoE network 3. In the VM service data center 2, Information Technology (IT) cell 11 including resources such as physical server and storage, internet gateway (GW) cell 10 and gateway cell 12, which include, for example, a gateway server, and management server 14 are connected to the network 13 such as a Local Area Network (LAN). As illustrated in FIG. 5, the virtual machine 17 and virtual router 18 may be activated in the IT cell 11, and the virtual internet GW 19 may be activated in the internet GW cell 10. The virtual machine 17 is connected one-to-one with the virtual router 18, and input/output of the data from/to the virtual machine 17 is controlled by the virtual router 18. A virtual OS and/or application programs for the customer PC 6 are activated in the virtual machine 17. The virtual router 18 is a firewall router that accepts only accesses from a specific customer PC 6. Moreover, the internet GW cell 10 is connected to the Internet 8 through a dedicated line, for example.

The management server 14 includes an IT cell manager 15 and router manager 16.

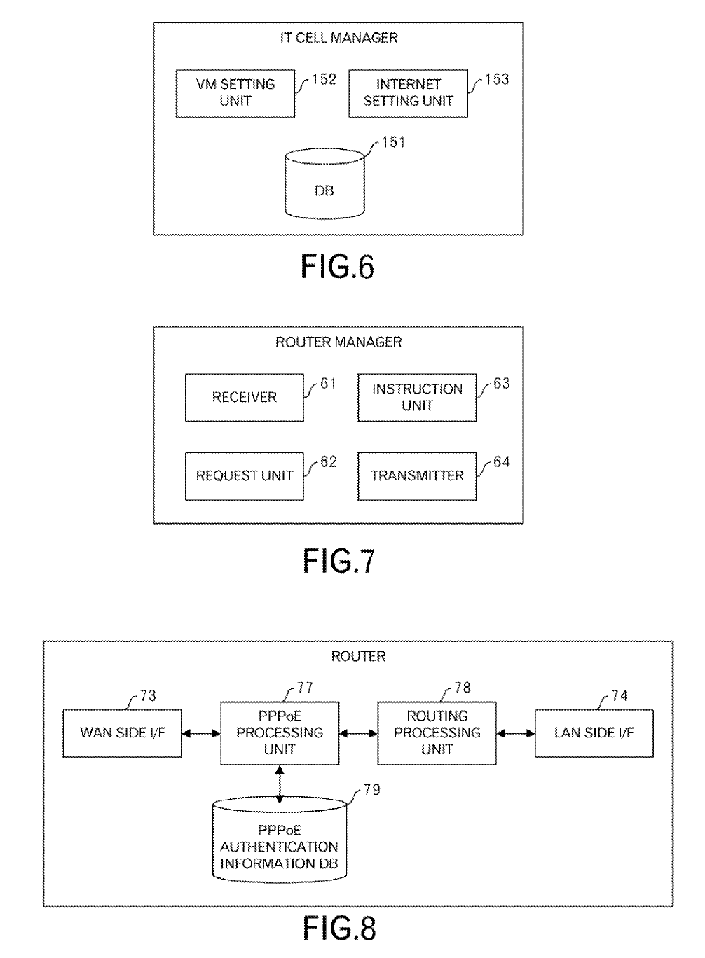

FIG. 6 illustrates a functional block diagram of the IT cell manager 15. The IT cell manager 15 includes a DB 151, VM setting unit 152 and internet setting unit 153. The VM setting unit 152 carries out a processing for causing the IT cell 11 to activate the virtual machine 17 and virtual router 18, and other processing. The internet setting unit 153 carries out a setting of the IP address for the virtual internet GW 19 activated in the internet GW cell 10 (e.g. NAT).

FIG. 7 illustrates a functional block diagram of the router manager 16. The router manager 16 includes a receiver 61, request unit 62, instruction unit 63 and transmitter 64. The receiver 61 receives data representing connection start and VM device information from the router 4, and receives PPPoE setting information for an operating stage from the communication carrier 9. The request unit 62 carries out a processing to transmit a setting request of the IP-VAN for the operating stage to the communication carrier 9. The instruction unit 63 carries out a processing to instruct the IT cell manager 16 to activate the virtual router 18 and virtual internet GW 19, and other processing. The transmitter 64 carries out a processing to transmit the setting information of the PPPoE for the operating stage to the router 4 and GW cell 12, and other processing.

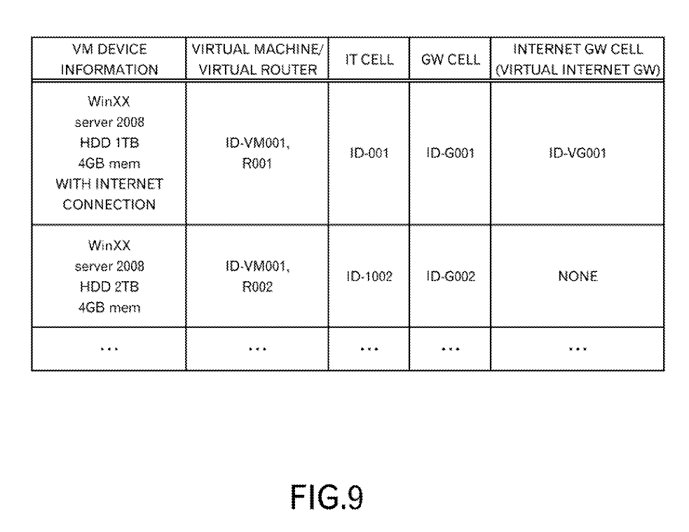

FIG. 8 illustrates a functional block diagram of the router 4. The router 4 includes a WAN side interface (I/F) 73, PPPoE processing unit 77, PPPoE authentication information DB 79, routing processing unit 78 and LAN side I/F 74. The PPPoE processing unit 77 carries out a processing to connect through the IP-VAN to the VM service data center 2 by using PPPoE setting information for a setting stage or IP-VAN setting information for the operating stage, which is stored in the PPPoE authentication information DB 79. The routing processing unit 78 carries out routing for relaying communication between the PPPoE network 3 and the network 5. For example, a cable for optical communication is connected to the WAN side I/F 73, and a LAN cable is connected to the LAN side I/F 74 in order to communicate data with connected destinations. Incidentally, VM device information that is data concerning the specification of the virtual machine and PPPoE setting information (e.g. PPPoE-ID and password) for the setting stage are registered in the PPPoE authentication information DB 79. Such information is information registered in the manufacturing of the router 4, for example.

FIG. 9 illustrates an example of data stored in a DB 151. In an example of FIG. 9, identifiers (IDs) of the virtual machine and virtual router, ID of the IT cell 11, ID of GW cell 12 and ID of the internet GW cell 10 are stored in association with the VM device information. As for the VM device information, “WinXX server 2008” represents a type of OS, and “HDD 1TB 4 GB mem” represents specification of the hardware. Namely, the capacity of the HDD is “1 TBytes”, and the capacity of the main memory is “4 GBytes”. Moreover, when the VM device information includes data “with connection with the Internet”, a processing for connecting the customer PC 6 and virtual machine 17 to connect with the Internet is carried out.

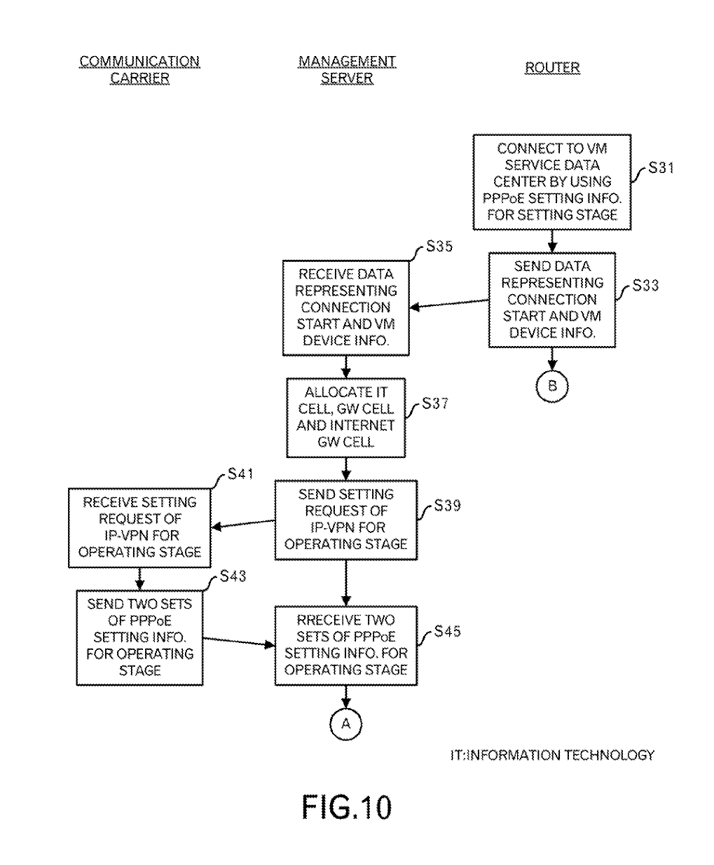

Next, processing contents of the system illustrated in FIG. 5 will be explained by using FIGS. 10 to 12. As a precondition, it is assumed that a user of the customer PC 6 has connected an optical fiber cable to the WAN side I/F 73 of the router 4, has connected a cable for the intranet to the LAN side I/F 74, and has turned on the power switch of the router 4.

First, the PPPoE processing unit 77 of the router 4 uses PPPoE setting information for the setting stage, which is stored in the PPPoE authentication information DB 79 to connect through the IP-VAN to the VM service data center 2 (FIG. 10: step S31). Incidentally, the PPPoE-ID for the setting stage is data in a format such as “faucet-user-123456@ facet.sop.fj.com”, and includes a domain name that identifies the VM service data center 2 and the ID of the router 4.

Then, the PPPoE processing unit 77 reads out the VM device information stored in the PPPoE authentication information DB 79, and transmits the VM device information and data representing the connection start to the management server 14 in the VM service data center 2 (step S33). Here, when a host name of the management server 14 is “faucet-mng.cloud.fj.com”, the PPPoE processing unit 77 invokes a PUT method to “http://faucet-mng.cloud.fj.com” to transmit the aforementioned data.

When the receiver 61 included in the management server 14 in the VM service data center 2 receives the data representing the connection start and VM device information from the router 4, the receiver 61 stores the received data into a storage device such as a main memory (step S35).

Then, the instruction unit 63 allocates the IT cell 11, GW cell 12 and internet GW cell 10 for the customer PC 6 (step S37). At the step S37, the instruction unit 63 notifies the VM setting unit 152 in the IT cell manager 15 of the VM device information, and the VM setting unit 152 identifies and allocates the IT cell 11, GW cell 12 and internet GW cell 10, which correspond to the VM device information, from the DB 151.

Then, the request unit 62 transmits a setting request of the IP-VAN for the operating stage to the communication carrier 9 (step S39). The processing of the step S39 may be a processing that the management server 14 displays a web page of the communication carrier 9 on a display device, accepts inputs of data for the setting request from an administrator, and sends the setting request including input data to the communication carrier 9.

On the other hand, the communication carrier 9 receives the setting request of the IP-VAN for the operating stage from the VM service data center 2 (step S41). Then, the communication carrier 9 generates two sets of PPPoE setting information for the operating stage, which includes the PPPoE-ID and password. Moreover, the communication carrier 9 transmits the generated PPPoE setting information to the VM service data center 2 (step S43).

Incidentally, a charge occurs when the PPPoE setting information is obtained from the communication carrier 9, for example. Therefore, when the PPPoE setting information for the operating stage is allocated in the manufacturing of the router, the service provider of the VM service data center 2 bears the charge for the routers in stock. Then, the PPPoE setting information for the setting stage is commonly assigned, for example, to the plural routers 4, and after the operation of the router 4 actually begins, the PPPoE setting information for the operating stage is allocated for each of the routers 4. Accordingly, the cost is reduced.

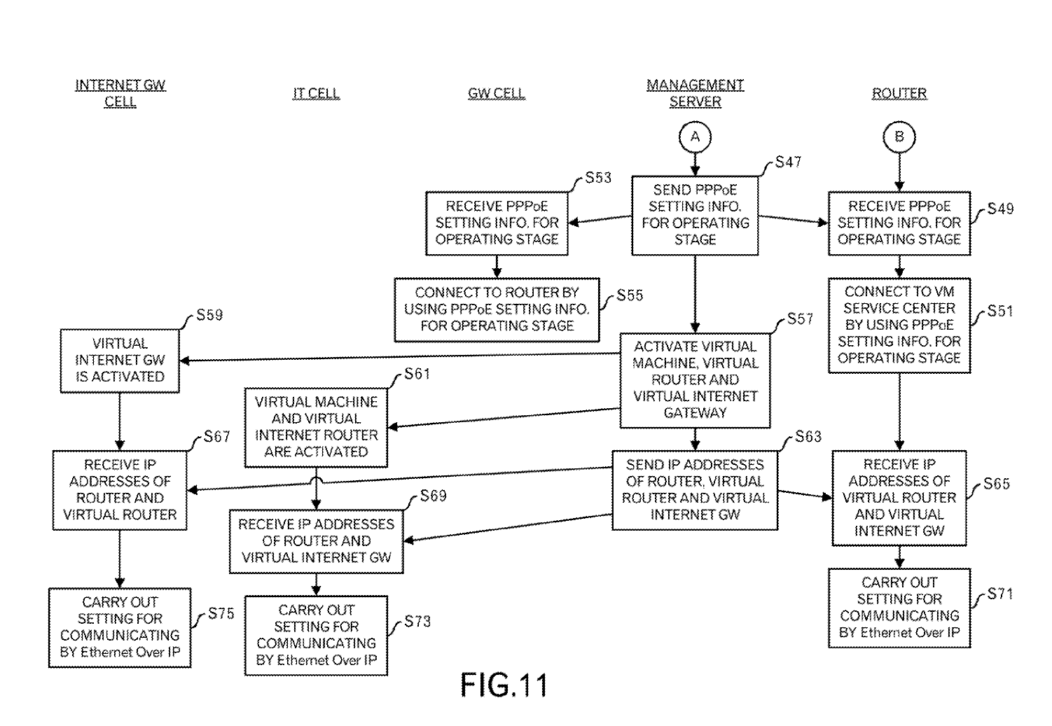

Returning to the explanation of FIG. 10, the receiver 61 included in the management server 14 in the VM service data center 2 receives two sets of the PPPoE setting information for the operating stage, and stores the received data into the storage device such as the main memory (step S45). Then, the processing shifts to a processing of FIG. 11 through terminals A and B.

Shifting to explanation of FIG. 11, the transmitter 64 in the management server 14 transmits the PPPoE setting information for the operating stage to the router 4 and GW cell 12 allocated at the step S37 (FIG. 11: step S47). Namely, one set of the PPPoE setting information for the operating stage, which was received at the step S45, is set to the router 4, and another set of the PPPoE setting information for the operating stage is set to the GW cell 12.

On the other hand, the WAN side I/F 73 in the router 4 receives the PPPoE setting information for the operating stage from the VM service data center 2, and stores the received data into the storage device such as the main memory (step S49). Then, the PPPoE processing unit 77 connects to the VM service data center 2 through the IP-VPN by using the PPPoE setting information for the operating stage (step S51).

Similarly, the GW cell 12 receives the PPPoE setting information for the operating stage from the management server 14 (step S53). Then, the GW cell 12 connects through the IP-VPN to the router 4 by using the PPPoE setting information for the operating stage (step S55).

Then, the instruction unit 63 in the management server 14 activates the virtual machine 17, virtual router 18 and virtual internet GW 19 (step S57). At the step S57, firstly the instruction unit 63 instructs the VM setting unit 152 and internet setting unit 153 to activate the virtual machine 17, virtual router 18 and virtual internet GW 19. In response to this, the VM setting unit 152 causes the IT cell 11 allocated at the step S37 to activate the virtual machine 17 and virtual router 18 by using a VM image, and causes the internet GW cell 10 allocated at the step S37 to activate the virtual internet GW 19 by using a VM image. Moreover, the internet setting unit 153 carries out a setting of the IP address to connect from the customer PC 6 and virtual machine 17 to the Internet for the internet GW cell 10. For example, a setting to convert the IP address of the router 4 and virtual router 18 to the global IP address (e.g. NAT) is carried out.

When the processing of the step S57 is carried out, the virtual internet GW is activated in the internet GW cell 10 (step S59), and the virtual machine 17 and virtual router 18 are activated in the IT cell 11 (step S61).

Then, the transmitter 64 transmits the IP addresses of the virtual router 18 and virtual internet GW 19 to the router 4, transmits the IP addresses of the router 4 and virtual internet GW 19 to the virtual router 18, and transmits the IP addresses of the router 4 and virtual router 18 to the virtual internet GW 19 (step S63). Incidentally, the processing of the step S63 may be carried out when an acquisition request of the IP address (e.g. a request message to obtain the IP address from “http://faucet-mng.cloud.fj.com/etherip-param” that is a registration destination of the IP address) is received.

On the other hand, the WAN side I/F 73 in the router 4 receives the IP addresses of the virtual router 18 and virtual internet GW 19 from the VM service data center 2 (step S65). Moreover, the virtual internet GW 19 receives the IP addresses of the router 4 and virtual router 18 from the management server 14 (step S67). In addition, the virtual router 18 receives the IP addresses of the router 4 and virtual internet GW 19 (step S69).

Then, the router 4 carries out a setting to communicate with the virtual router 18 and virtual internet GW 19 by the Ethernet Over IP (step S71). For example, the IP address received at the step S65 is registered into a table and the like in the router 4. Similarly, the virtual router 18 carries out a setting for communicating with the router 4 and virtual internet GW 19 by the Ethernet Over IP (step S73), and the virtual internet GW 19 carries out a setting for communicating with the internet GW 19 and router 4 by the Ethernet Over IP (step S75). Incidentally, the Ethernet Over IP is a technique to encapsulate data (specifically, Ethernet frame) into the IP packet to communicate with each other.

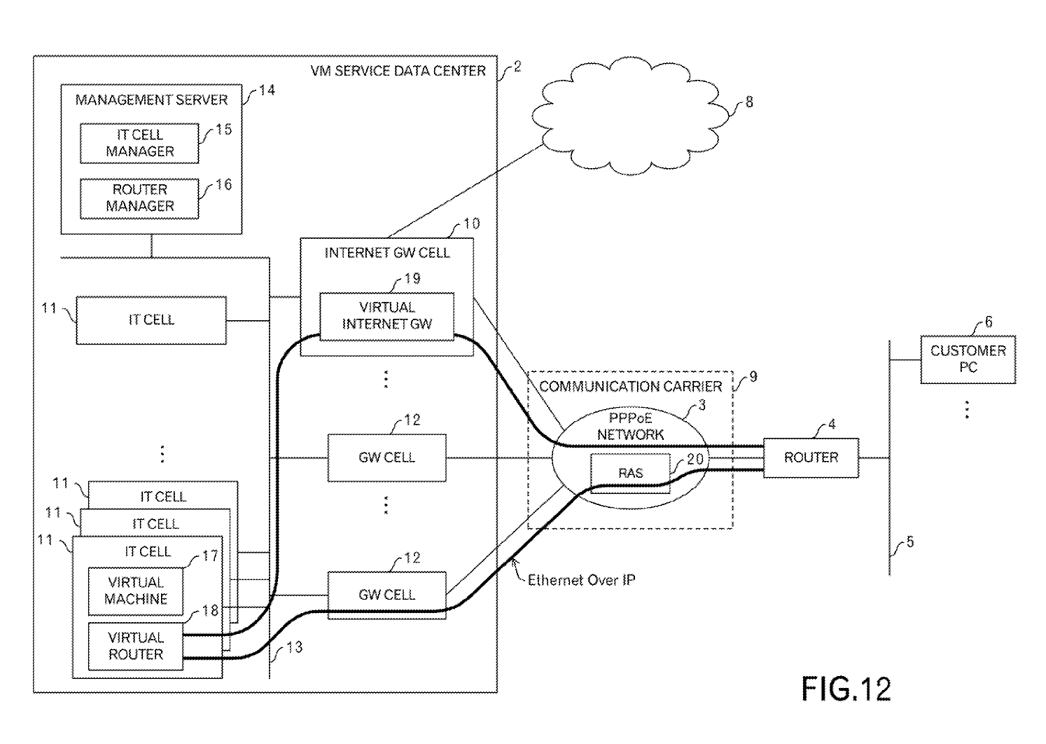

FIG. 12 conceptually illustrates a route of the Ethernet Over IP, which is set by the processing from the steps S71 to S73. As depicted in FIG. 12, the router of the Ethernet Over IP are set “between the router 4 and the virtual router 18”, “between the router 4 and the virtual internet GW 19” and “between the virtual router 18 and the virtual internet GW 19”. Incidentally, when the route of the Ethernet Over IP is set, the IP-VPN for the setting stage is disconnected.

As described above, when the power is supplied to the router 4, the virtual machine 17 and virtual internet GW 19 are prepared in the VM service data center 2. Therefore, the virtual machine 17 and the Internet can be easily utilized from the customer PC 6.

Moreover, because the router 4 and VM service data center 2 are connected through the IP-VAN, the user of the customer PC 6 can communicate securely. In addition, because the virtual internet GW 19 is provided in the VM service data center 2 and the security setting for the router is not carried out at the user side, it is convenient for the user.

Furthermore, when the router 4 is connected to the VM service data center 2, the virtual machine 17 and the like are prepared, and extra resources are not consumed. Therefore, the running cost can be reduced.

Although the embodiments of this technique were explained above, this technique is not limited to those. For example, the functional blocks of the management server 14 and router 4 do not always correspond to actual program module configurations.

Moreover, the construction of each table explained above is a mere example, and the aforementioned construction may be changed. Furthermore, as long as the processing result does not change, the order of the steps may be exchanged or the steps may be executed in parallel.

In addition, in the second embodiment, the management server 14 includes the IT cell manager 15 and router manager 16. However, the IT cell manager 15 and router manager 16 may be included in other apparatus, respectively.

Furthermore, the customer PC 6 may be directly connected with the router 4.

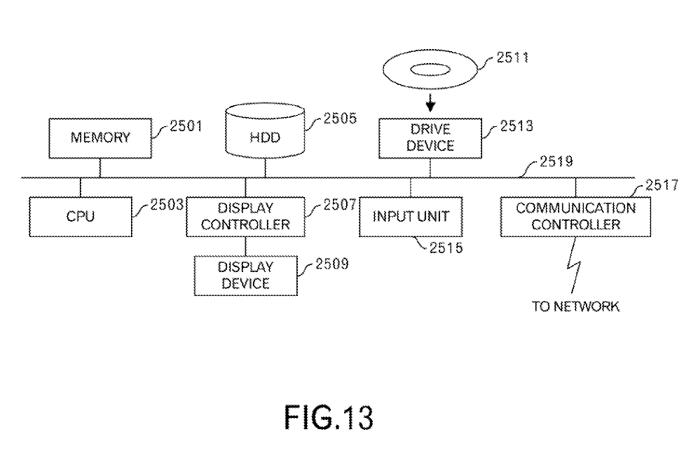

In addition, the management server 14 and customer PC 6 are computer devices as shown in FIG. 13. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 13. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the computer-readable removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

In addition, the respective processing units depicted in FIGS. 6 to 8 may be realized by a combination of the CPU 2503 and programs, namely, by the CPU 2503 executing the programs. More specifically, the CPU 2503 operates according to the programs stored in the HDD 2505 and/or memory 2501 to realize the aforementioned processing units. Furthermore, the respective data storage unit depicted in FIGS. 6 to 8 may be realized by the memory 2501 and/or HDD 2505 in FIG. 13 or the like.

The aforementioned embodiments are outlined as follows:

A management method relating to a first aspect of the embodiments is executed by a management apparatus in a data center. Then, this method includes: (A) receiving, from a router that starts connecting to a data center through a virtual private network, data concerning specification of a virtual machine for a user terminal in a network connected to the router and data representing a request for connecting to the Internet; (B) activating a first virtual machine satisfying the specification of the virtual machine on a computer in the data center; (C) activating a virtual internet gateway that is a second virtual machine for connecting to the Internet on a computer in the data center; (D) carrying out a setting of an address by which the user terminal connects to the Internet, for the virtual internet gateway; (E) transmitting an address of the first virtual machine and an address of the virtual internet gateway to the router; and (F) transmitting an address of the router to the first virtual machine and the virtual internet gateway.

Thus, when connection between the data center and the router starts, the first virtual machine and virtual internet gateway are automatically prepared. Therefore, it becomes possible for the user terminal to easily utilize the first virtual machine and the Internet. Incidentally, the virtual internet gateway is provided in the data center side, and no security setting task is required in the user side. Therefore, it is convenient for the user.

In addition, the aforementioned carrying may include: carrying out a setting of an address by which the first virtual machine connects to the Internet, for the virtual internet gateway. Moreover, the aforementioned management method may further include: transmitting the address of the virtual internet gateway to the first virtual machine; and transmitting the address of the first virtual machine to the virtual internet gateway. Thus, it becomes possible to connect to the Internet from the first virtual machine in addition to the user terminal.

A router relating to a second aspect of the embodiments is a router for relaying communication between a first network and a second network. Then, the router includes: (A) a data storage unit storing data concerning specification of a virtual machine for a user terminal in the second network, and connection request data representing a connection request to the Internet; (B) a reader that reads out the data concerning the specification of the virtual machine and the data connection request data from the data storage unit, upon connecting to a data center through a virtual private network on the first network; (C) a communication unit that transmits the data concerning the specification of the virtual machine and the data connection request data, which are read out by the reader, to the data center through the virtual private network on the first network, and receives, from the data center, connection information including an address of a first virtual server satisfying the specification of the virtual machine and an address of a second virtual server that carries out a processing for connecting to the Internet; and (D) a setting unit that carries out a setting for communicating with the first virtual server and the second virtual server by using the connection information received by the communication unit.

By employing such a configuration, when the user activates the router and the router is connected to the data center, the first and second virtual servers are automatically prepared in the data center. Therefore, it becomes possible to utilize the virtual machine and the Internet, easily.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program that causes a computer to execute a process, the process comprising:
receiving, from a router that starts connecting to a data center through a first network, data concerning specification of a virtual machine for a user terminal in a second network connected to the router and data representing a request for connecting to a third network;
activating a first virtual machine satisfying the specification of the virtual machine on a computer in the data center;
activating a second virtual machine for connecting to the third network on a computer in the data center;
carrying out a setting of an address by which the user terminal connects to the third network, for the second virtual machine;
transmitting an address of the first virtual machine and an address of the second virtual machine to the router; and
transmitting an address of the router to the first virtual machine and the second virtual machine.

2. The computer-readable, non-transitory storage medium as set forth in claim 1, wherein the carrying comprises:
carrying out a setting of an address by which the first virtual machine connects to the third network, for the second virtual machine, and
the process further comprises:
transmitting the address of the second virtual machine to the first virtual machine; and
transmitting the address of the first virtual machine to the second virtual machine.

3. A router for relaying communication between a first network and a second network, the router comprising:
a data storage unit storing data concerning specification of a virtual machine for a user terminal in the second network, and connection request data representing a connection request to a third network;
a reader that reads out the data concerning the specification of the virtual machine and the data connection request data from the data storage unit, upon connecting to a data center through the first network;
a communication unit that transmits the data concerning the specification of the virtual machine and the data connection request data, which are read out by the reader, to the data center through the first network, and receives, from the data center, connection information including an address of a first virtual machine satisfying the specification of the virtual machine and an address of a second virtual machine that carries out a processing for connecting to the third network; and
a setting unit that carries out a setting for communicating with the first virtual machine and the second virtual machine by using the connection information received by the communication unit.

4. A management apparatus comprising:
a receiver that receives, from a router that starts connecting to a data center through a first network, data concerning specification of a virtual machine for a user terminal in a second network connected to the router and data representing a request for connecting to a third network;
a first processing unit that activates a first virtual machine satisfying the specification of the virtual machine on a computer in the data center;
a second processing unit that activates a second virtual machine for connecting to the third network on a computer in the data center, and carries out a setting of an address by which the user terminal connects to the third network, for the second virtual machine; and
a transmitter that transmits an address of the first virtual machine and an address of the second virtual machine to the router, and transmits an address of the router to the first virtual machine and the second virtual machine.

5. A management method comprising:
receiving, from a router that starts connecting to a data center through a first network, data concerning specification of a virtual machine for a user terminal in a second network connected to the router and data representing a request for connecting to a third network;
activating a first virtual machine satisfying the specification of the virtual machine on a computer in the data center;
activating a second virtual machine for connecting to the third network on a computer in the data center;
carrying out a setting of an address by which the user terminal connects to the third network, for the second virtual machine;
transmitting an address of the first virtual machine and an address of the second virtual machine to the router; and
transmitting an address of the router to the first virtual machine and the second virtual machine.

6. A computer-readable, non-transitory storage medium storing a program that causes a router relaying communication between a first network and a second network to execute a process, the process comprising:
upon connecting to a data center through the first network, reading out, from a data storage unit, data concerning specification of a virtual machine for a user terminal in the second network, and connection request data representing a connection request to a third network;
transmitting the data concerning the specification of the virtual machine and the data connection request data to the data center through the first network; and
upon receiving, from the data center, connection information including an address of a first virtual machine satisfying the specification of the virtual machine and an address of a second virtual machine that carries out a processing for connecting to the third network, carrying out a setting for communicating with the first virtual machine and the second virtual machine.

7. A router control method comprising:
upon connecting to a data center through a first network connected to a router, reading out, from a data storage unit, data concerning specification of a virtual machine for a user terminal in a second network connected to the router, and connection request data representing a connection request to a third network;
transmitting the data concerning the specification of the virtual machine and the data connection request data to the data center through the first network; and
upon receiving, from the data center, connection information including an address of a first virtual machine satisfying the specification of the virtual machine and an address of a second virtual machine that carries out a processing for connecting to the third network, carrying out a setting for communicating with the first virtual machine and the second virtual machine.
